(19) United States
(12) Patent Application Publication
(10) Pub. No.: US 2021/0232263 A1
(43) Pub. Date: Jul. 29, 2021

(54) TOUCH PANEL

(71) Applicant: WUHAN CHINA STAR OPTOELECTRONICS SEMICONDUCTOR DISPLAY TECHNOLOGY CO., LTD., Wuhan,Hubei (CN)

(72) Inventor: Xiaoliang FENG, Wuhan,Hubei (CN)

(21) Appl. No.: 16/301,447

(22) PCT Filed: Sep. 11, 2018
(86) PCT No.: PCT/CN2018/105099

§ 371 Date: Nov. 14, 2018

(30) Foreign Application Priority Data
Aug. 6, 2018 (CN) 201810883360.9

(51) Int. Cl. G06F 3/044; G06F 3/041

(52) U.S. Cl. CPC G06F 3/0446; G06F 2203/04111; G06F 3/04164; G06F 3/0443

(57) ABSTRACT

A touch panel includes a substrate and a touch layer disposed on the substrate. The touch layer includes at least two first touch electrodes arranged along a first direction, at least four second touch electrodes, where at least two of the second touch electrodes are arranged along the first direction or a second direction. The second touch electrodes are embedded in the first touch electrodes. The first touch electrodes are insulated from the second touch electrodes.

The present disclosure relates to the field of touch technologies, and more particularly to a touch panel.

### BACKGROUND

With a rapid development of display technology, touch applications are introduced in various digital electronic products. Touch technology provides a new human-computer interaction interface, and touch technology and display technology are integrated to form a touch display device, which can perform input through a finger and a stylus, making creation to be easier and more intuitive.

At present, more commonly used touch technologies mainly include out-cell touch technology and in-cell touch technology. Because in-cell touch technology can make display devices thinner and lighter than out-cell touch technology, an organic light emitting diode (OLED) display device is more concerned with an application of the in-cell touch technology. When an in-cell touch layer is fabricated on an OLED display panel, a mutual capacitance signal of the touch layer is subject to a large noise interference due to influence of a cathode of the OLED, especially for flexible OLEDs, an encapsulation layer of the flexible OLED is thinner, and the mutual capacitance signal of the touch layer is influenced by noise. How to increase the mutual capacitance of the touch layer and improve a touch sensitivity is a problem faced by the in-cell touch of the OLED panel. The prior art introduces a boost device (pump) in a driver integrated circuit to increase intensity of touch signals, but this approach increases power consumption.

In summary the mutual capacitance signal of the touch layer of the existing touch panel is susceptible to large interference, thereby influencing touch sensitivity.

### SUMMARY OF THE DISCLOSURE

The present disclosure provides a touch panel to solve a technical problem that in the existing touch panel, a noise of an OLED cathode interferes with a mutual capacitance signal of a touch layer, thereby influencing a touch sensitivity and display.

In order to solve technical problems described above, the technical solution provided by the present disclosure is as follows.

The present disclosure provides a touch panel, including a substrate and a touch layer disposed on the substrate, where the touch layer includes:

at least two first touch electrodes arranged along a first direction; and

second touch electrodes arranged in an array, where at least two of the second touch electrodes are arranged alone the first direction or a second direction; and

the second touch electrodes are embedded in the first touch electrodes; the first touch electrodes are insulated from the second touch electrodes; and at least two of the second touch electrodes arranged along the second direction are embedded in the same first touch electrode.

In one embodiment of the present disclosure, a first metal disconnection area is formed between the first touch electrode and the second touch electrode embedded in the first touch electrode.

In one embodiment of the present disclosure, the first touch electrode includes at least two openings which are spaced apart from each other, and the second touch electrodes are located in the openings.

In one embodiment of the present disclosure, a second metal disconnection area is formed between each of the first touch electrodes and the adjacent first touch electrodes.

In one embodiment of the present disclosure, the touch panel further includes a bridge connection layer, a first insulation layer, and a second insulation layer.

In one embodiment of the present disclosure, the first insulation layer is disposed on the touch layer, the bridge connection layer is disposed on the first insulation layer, and the second insulation layer is disposed on the bridge connection layer.

In one embodiment of the present disclosure, the bridge connection layer includes conductive bridges arranged in an array, and each of the conductive bridges connects two adjacent second touch electrodes arranged along the first direction.

In one embodiment of the present disclosure, the first touch electrode, the second touch electrode, and the conductive bridge are mesh structures made from crisscrossed metal wires.

In one embodiment of the present disclosure, the touch panel further includes a binding pad and a surrounding trace, where the surrounding trace connects to both the first touch electrodes, the second touch electrodes, and the binding pad.

The present disclosure also provides a touch panel, including a substrate and a touch layer disposed on the substrate, where the touch layer includes:

at least two first touch electrodes arranged along a first direction;

second touch electrodes arranged in an array, where at least two of the second touch electrodes are arranged along the first direction or a second direction;

the second touch electrodes are embedded in the first touch electrodes; and the first touch electrodes are insulated from the second touch electrodes.

In one embodiment of the present disclosure, a first metal disconnection area is formed between the first touch electrode and the second touch electrode embedded in the first touch electrode.

In one embodiment of the present disclosure, the first touch electrode includes at least two openings which are spaced apart from each other, and the second touch electrodes are located in the openings.

In one embodiment of the present disclosure, a second metal disconnection area is formed between each of the first touch electrodes and the adjacent first touch electrodes.

In one embodiment of the present disclosure, the touch panel further includes a bridge connection layer, a first insulation layer, and a second insulation layer.

In one embodiment of the present disclosure, the first insulation layer is disposed on the touch layer, the bridge connection layer is disposed on the first insulation layer, and the second insulation layer is disposed on the bridge connection layer.

In one embodiment of the present disclosure, the bridge connection layer includes conductive bridges arranged in an array, and each of the conductive bridges connects two adjacent second touch electrodes arranged along the first direction.

In one embodiment of the present disclosure, the first touch electrode, the second touch electrode, and the conductive bridge are mesh structures made from crisscrossed metal wires.

In one embodiment of the present disclosure, the touch panel further includes a binding pad and a surrounding trace, where the surrounding trace connects to both the first touch electrodes, the second touch electrodes, and the binding pad.

The present disclosure has the advantage that by embedding the second touch electrode in the first touch electrode, the contact area is increased, the distance between the two electrodes is reduced, and the mutual capacitance of the touch layer is increased, thereby improving an intensity of the touch signal.

### BRIEF DESCRIPTION OF THE DRAWINGS

In order to more clearly describe the technical solutions of the embodiments of the present disclosure, accompanying drawings to be used in the detailed description of the disclosure will be briefly described hereinbelow. Obviously, the accompanying drawings described hereinbelow only illustrate some of the embodiments of the present disclosure, and those of ordinary skill in the art can also obtain other accompanying drawings therefrom without the need of making inventive efforts.

FIG. 1 is a schematic diagram of a touch unit of a touch panel of the present disclosure.

FIG. 2 is a schematic diagram of a touch panel of the present disclosure.

FIG. 3 is a cross-sectional view along A-A line of FIG. 1.

FIG. 4 is a cross-sectional view along B-B line of FIG. 1.

FIG. 5 is a schematic diagram of a first touch electrode of a touch panel of the present disclosure.

FIG. 6 is a schematic diagram of a second touch electrode of a touch panel of the present disclosure.

### DETAILED DESCRIPTION

The following embodiments refer to the accompanying drawings for exemplifying specific implementable embodiments of the present disclosure. Moreover, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, the same reference symbol represents the same or similar components.

In the prior art touch panel, since an in-cell touch layer is formed on an OLED display panel, a mutual capacitance of the touch layer is influenced by a cathode and is thus subjected to great noise interference, thereby influencing a touch sensitivity and display. An embodiment of the present disclosure can solve this drawback.

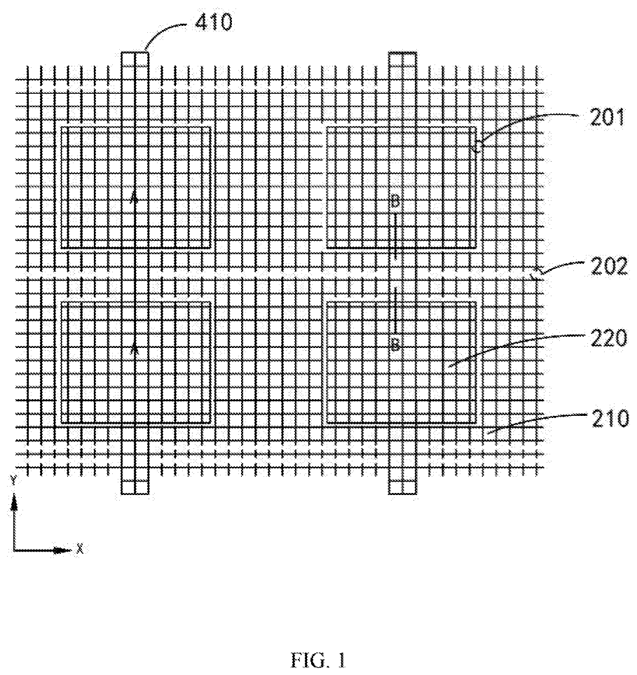

Referring to FIG. 1 to FIG. 4, an embodiment of the present disclosure provides a touch panel including a substrate 100, a touch layer formed on the substrate 100, a first insulation layer 300, a bridge connection layer which includes a plurality of conductive bridges 410, a second insulation layer 500, a surrounding trace 600, and a binding pad 700.

The touch layer includes a plurality of first touch electrodes 210 and a plurality of second touch electrodes 220. The first touch electrode 210 is a driving touch electrode, and the second touch electrode 220 is an inductive touch electrode. Alternatively, the first touch electrode 210 is an inductive touch electrode, and the second touch electrode 220 is a driving touch electrode.

In this embodiment, the substrate 100 is an OLED display panel, but is not limited thereto. The substrate 100 may also be a liquid crystal display panel, a glass substrate, a flexible substrate, or the like.

As shown in FIG. 1, a square boundary line of the second touch electrode 220 does not exist in an actual circuit, and the square boundary line is added for a convenience of graphic visualization, which makes the solution easier to understand. A line width of a rectangular boundary line of the conductive bridge 410 is the same as a line width of the second touch electrode 220 in the actual circuit. In order to facilitate distinguishing boundaries of respective structures, the boundary line of the conductive bridge 410 is bold in the schematic diagram.

The first touch electrode 210 and the second touch electrode 220 are metal mesh structures formed by metal wires. The second touch electrode 220 is embedded in the first touch electrode 210.

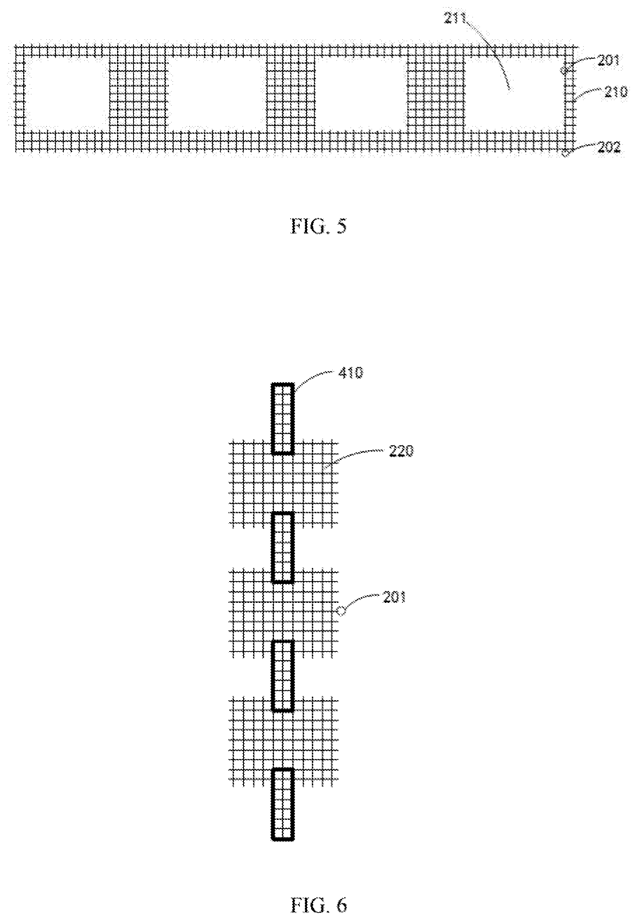

As shown in FIG. 1 and FIG. 5, the plurality of the first touch electrodes 210 are arranged along a first direction, and the first direction is a Y direction. The plurality of the first touch electrodes 210 are arranged in parallel. The first touch electrode 210 is provided with a plurality of openings 211, and the opening 211 is configured to accommodate the second touch electrode 220. By embedding, the second touch electrode 220 in the opening 211 of the first touch electrode 210, a direct contact area of the first touch electrode 210 and the second touch electrode 220 can be increased, and a distance between the two is decreased. It is beneficial to increase a mutual capacitance between the two, thereby enhancing the touch signal and effectively reducing the signal interference of an OLED cathode.

The plurality of the second touch electrodes 220 are arranged in an array. The plurality of second touch electrodes are arranged along the first direction or a second direction, and the second direction is an X direction. A plurality of the second touch electrodes 220 arranged along the X direction are embedded in the same first touch electrode 210, that is, a plurality of the second touch electrodes 220 in the same row are respectively located in a plurality of the openings 211 of the same first touch electrode 210.

A first metal disconnection area 201 is formed between an edge of each of the second touch electrodes 220 and an edge of a corresponding opening 211. That is, a gap is formed between the second touch electrode 220 embedded in the first touch electrode 210 and the first touch electrode 210. A width of the gap is 1 to 30 micrometers, and a specific size depends on actual design.

A second metal disconnection area 202 is formed between each of the first touch electrodes 210 and the adjacent first touch electrode 210. Two adjacent first touch electrodes 210 are insulated from each other by the second metal disconnection area 202. A width of the second metal disconnection area 202 is 1 to 30 micrometers, and a specific size depends on actual design.

In the touch layer fabrication process, the first touch electrode 210 and the second touch electrode 220 may be fabricated on the substrate 100 by the same patterning process.

As shown in FIG. 5, which is a schematic structural diagram of the first touch electrode 210. Each of the first touch electrodes 210 spans the entire substrate 100. The first touch electrode 210 is a mesh structure formed by a combination of a plurality of horizontal and vertical metal wires. The opening 211 is a square opening for accommodating the second touch electrode 220. The plurality of the openings 211 are spaced from each other on each of the first touch electrodes 210. The opening 211 is a closed structure surrounded by metal broken wires. An area of the opening 211 is slightly larger than an area of the second touch electrode 220.

As shown in FIG. 6, which is a schematic structural diagram of the second touch electrodes 220 arranged along the first direction (Y direction). The second touch electrode 220 is a square metal mesh structure made from crisscrossed metal wires.

The bridge connection layer includes a plurality of conductive bridges 410. The conductive bridge 410 connects the adjacent second touch electrodes 220 arranged along the Y direction, that is, in the Y direction. One of the conductive bridges 410 is disposed between the two second touch electrodes 220.

The conductive bridge 410 is a strip metal mesh structure made from crisscrossed metal wires. Two ends of the conductive bridge 410 are respectively connected to the two second touch electrodes 410. A metal grid line at an end of the conductive bridge 410 overlaps with a metal grid line of the second touch electrode 220 connected to the end, thereby forming a multiple metal grid line. An advantage of the multiple metal grid line is that the metal wires on the conductive bridge 410 can be interconnected, and even if the conductive bridge 410 is broken, the wires can be connected through other interconnected metal wires, thereby greatly reducing an influence of a line fault caused by a disconnection of the conductive bridge 410. At the same time, a resistance of the conductive bridge 410 can also be reduced, which is advantageous for increasing the mutual capacitance between the first touch electrode 210 and the second touch electrode 220.

The end of the conductive bridge 410 is directly connected to the second touch electrode 220. In addition, the other structure of the conductive bridge 410 is insulated from the second touch electrode 220.

In this embodiment, the conductive bridge 410 is a mesh structure made from crisscrossed metal wires, including eight transverse metal wires being parallel to each other and three longitudinal metal wires being parallel to each other.

As shown in FIG. 3, which is a schematic structural view of an A-A cross section of FIG. 1, and the A-A cross section is a section showing the metal wires of the conductive bridge 410 along the Y direction.

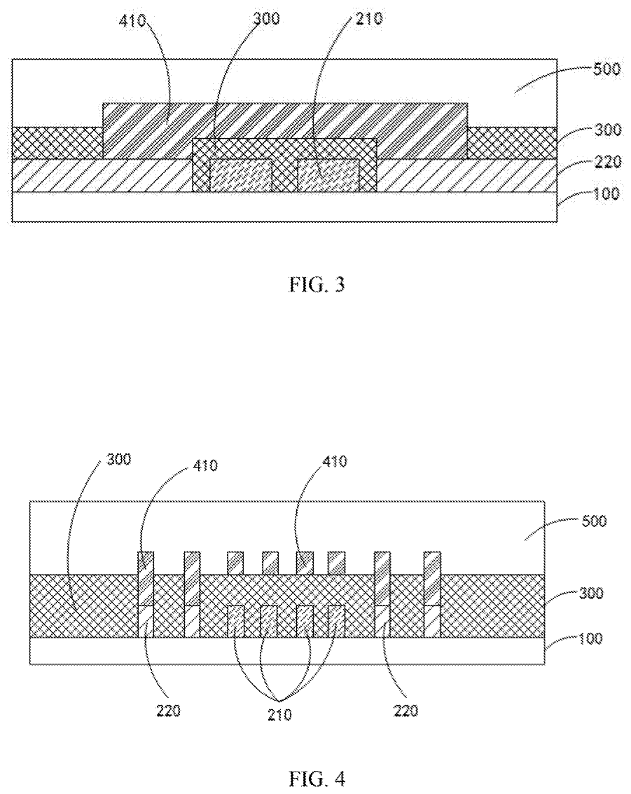

As shown in FIG. 4, which is a schematic structural view of a B-B cross section or FIG. 1, and the B-B cross section is offset from the section of the metal wires of the conductive bridge 410 along the Y direction.

The first insulation layer 300 is formed on the touch layer. The first metal disconnection area 201 and the second metal disconnection area 202 of the touch layer are filled by the first insulation layer 300. The first insulation layer 300 has a plurality of via holes for accommodating the conductive bridge 410.

In FIG. 3, the first insulation layer 300 has two via holes for respectively accommodating two ends on the conductive bridge 410. In FIG. 4, the first insulation layer 300 has four via holes for respectively accommodating an overlapping portion of the conductive bridge 410 and the second touch electrode 220. The first insulation layer 300 is used to protect the first touch electrode 210 such that the second touch electrode 220 and the conductive bridge 410 are not interfered with each other.

The conductive bridge 410 is formed on the first insulation layer 300. The conductive bridge 410 is directly connected to the second touch electrode 220 through the via holes of the first insulation layer 300.

The second insulation layer 600 is formed on the conductive bridge 410 for protect the touch layer.

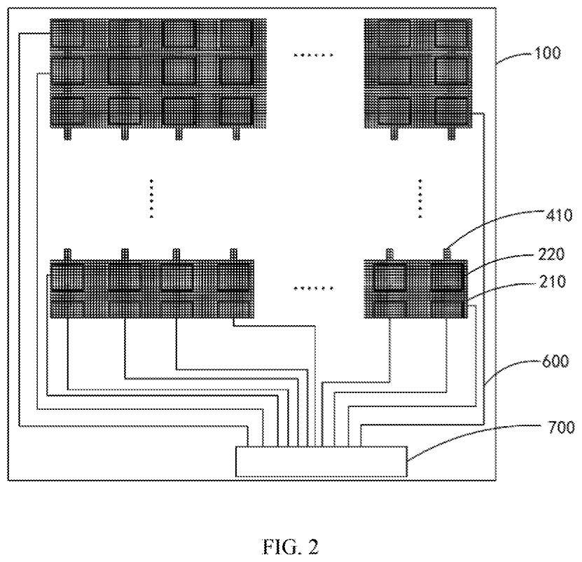

As shown in FIG. 2, the touch panel includes a plurality of surrounding traces 600. The surrounding traces are used to connect the first touch electrode 210, the second touch electrode 220, and the binding pad 700.

One of the surrounding traces 600 connects one second touch electrode 220 located at an edge region of the touch layer, or connects one of the first touch electrodes 210.

The present disclosure has the advantage that by embedding the second touch electrode in the first touch electrode, the contact area is increased, the distance between the two electrodes is reduced, and the mutual capacitance of the touch layer is increased, thereby improving intensity of the touch signal.

The above descriptions are merely preferable embodiments of the present disclosure, and are not intended to limit the scope of the present disclosure. Any modification or replacement made by those skilled in the art without departing from the spirit and principle of the present disclosure should fall within the protection scope of the present disclosure. Therefore, the protection scope of the present disclosure is subject to the appended claims.

1. A touch panel, comprising a substrate and a touch layer disposed on the substrate, wherein the touch layer comprises:
at least two first touch electrodes which are arranged along a first direction; and
second touch electrodes arranged in an array, wherein at least two of the second touch electrodes are arranged along the first direction or a second direction; and
wherein the second touch electrodes are embedded in the first touch electrodes; the first touch electrodes are insulated from the second touch electrodes; and at least two of the second touch electrodes arranged along the second direction are embedded in the same first touch electrode.

2. The touch panel as claimed in claim 1, wherein a first metal disconnection area is formed between the first touch electrode and the second touch electrode embedded in the first touch electrode.

3. The touch panel as claimed in claim 2, wherein the first touch electrode comprises at least two openings which are spaced apart from each other, and the second touch electrodes are located in the openings.

4. The touch panel as claimed in claim 1, wherein a second metal disconnection area is formed between each of the first touch electrodes and the adjacent first touch electrodes.

5. The touch panel as claimed in claim 1, further comprising a bridge connection layer, a first insulation layer, and a second insulation layer.

6. The touch panel as claimed in claim 5, wherein the first insulation layer is disposed on the touch layer, the bridge connection layer is disposed on the first insulation layer, and the second insulation layer is disposed on the bridge connection layer.

7. The touch panel as claimed in claim 5, wherein the bridge connection layer comprises conductive bridges arranged in an array, and each of the conductive bridges connects two adjacent second touch electrodes arranged along the first direction.

8. The touch panel as claimed in claim 7, wherein the first touch electrode, the second touch electrode, and the conductive bridge are mesh structures made from crisscrossed metal wires.

9. The touch panel as claimed in claim 1, further comprising a binding pad and a surrounding trace, wherein the surrounding trace connects the first touch electrodes, the second touch electrodes, and the binding pad, respectively.

10. A touch panel, comprising a substrate and a touch layer disposed on the substrate, wherein the touch layer comprises:
at least two first touch electrodes which are arranged along a first direction; and
second touch electrodes arranged in an array, wherein at least two of the second touch electrodes are arranged along the first direction or a second direction; and
wherein the second touch electrodes are embedded in the first touch electrodes; and the first touch electrodes are insulated from the second touch electrodes.

11. The touch panel as claimed in claim 10, wherein a first metal disconnection area is formed between the first touch electrode and the second touch electrode embedded in the first touch electrode.

12. The touch panel as claimed in claim 11, wherein the first touch electrode comprises at least two openings which are spaced apart from each other, and the second touch electrodes are located in the openings.

13. The touch panel as clamed in claim 10, wherein a second metal disconnection area is formed between each of the first touch electrodes and the adjacent first touch electrodes.

14. The touch panel as clamed in claim 10, further comprising a bridge connection layer, a first insulation layer, and a second insulation layer.

15. The touch panel as claimed in claim 14, wherein the first insulation layer disposed on the touch layer, the bridge connection layer is disposed on the first insulation layer, and the second insulation layer is disposed on the bridge connection layer.

16. The touch panel as claimed in claim 14, wherein the bridge connection layer comprises conductive bridges arranged in an array, and each of the conductive bridges connects two adjacent second touch electrodes arranged along the first direction.

17. The touch panel as claimed in claim 16, wherein the first touch electrode, the second touch electrode, and the conductive bridge are mesh structures made from crisscrossed metal wires.

18. The touch panel as claimed in claim 10, further comprising binding pad and a surrounding trace, wherein the surrounding trace connects the first touch electrodes, the second touch electrodes, and the binding pad, respectively.
